(19) United States
(12) Patent Application Publication
(10) Pub. No.: US 2024/0198521 A1
(43) Pub. Date: Jun. 20, 2024

(54) ROBOT SYSTEM

(71) Applicant: SAMSUNG ELECTRONICS CO., LTD., Suwon-si (KR)

(72) Inventors: Takeshi YAMAGISHI, Yokohama-shi (JP); Masaru OKUDA, Yokohama-shi (JP); Yuki ABE, Yokohama-shi (JP)

(73) Assignee: SAMSUNG ELECTRONICS CO., LTD., Suwon-si (KR)

(21) Appl. No.: 18/529,704

(22) Filed: Dec. 5, 2023

Related U.S. Application Data
(63) Continuation of application No. PCT/KR23/18097, filed on Nov. 10, 2023.

(30) Foreign Application Priority Data
Dec. 19, 2022 (JP) 2022-202156

(51) Int. Cl. B25J 9/16

(52) U.S. Cl. CPC B25J 9/1664

(57) ABSTRACT

A robot system includes: an arm part; a tool part; and a connection part including a receiving part and a projection part, wherein the receiving part is provided on one of the arm part and the tool part, and the projection part is provided on the other one of the arm part and the tool part, and the receiving part is configured to connect the arm part and the tool part by securely receiving the projection part, and to disconnect the arm part from the tool part by releasing the projection part.

### CROSS-REFERENCE TO RELATED APPLICATIONS

This application is a bypass continuation of International Application No. PCT/KR2023/018097, filed on Nov. 10, 2023, which is based on and claims priority to Japanese Patent Application No. 2022-202156, filed on Dec. 19, 2022, in the Japanese Patent Office, the disclosures of which are incorporated by reference herein in their entireties.

### BACKGROUND

### 1. Field

The disclosure relates to a robot system operable to securely grip a tool part.

### 2. Description of Related Art

Patent Document 1 discloses a configuration for storing a releasable end effector for a manipulator arm. In this configuration, the end effector includes a releasable latch device for connecting the end effector to the manipulator arm. Also, a storage holder including components for operating the latch device when the end effector comes in and gets out of the holder due to an operation of the manipulator arm is provided.

Patent Document 2 discloses a system for installing a tool to be exchangeable on a robot arm. This system includes a clamp assembly having a core that is installed on an arm and extends in a length direction from the arm, and two clamp members facing each other that are installed to slide on the core in a transverse direction. A tool supporting member is kept in the clamp assembly when the clamp assembly is closed by a guide pin that exists to extend in a transverse direction from the clamp member coupled with the leg portion of the tool supporting member.
Patent Document 1: Specification of U.S. Pat. No. 4,913,617
Patent Document 2: Specification of U.S. Pat. No. 4,784,421.

### SUMMARY

If a configuration wherein an arm part and a tool part of a robot are made to be connected as a receiving part fits a projection part, and the connection between the arm part and the tool part is released as the receiving part releases the fitting with the projection part is not adopted, the arm part cannot securely grip the tool part.

The disclosure provides an arm part operable to securely grip the tool part.

According to an aspect of the disclosure, a robot system includes: an arm part; a tool part; and a connection part including a receiving part and a projection part, wherein the receiving part is provided on one of the arm part and the tool part, and the projection part is provided on the other one of the arm part and the tool part, and the receiving part is configured to connect the arm part and the tool part by securely receiving the projection part, and to disconnect the arm part from the tool part by releasing the projection part.

The receiving part may include: a cam; an actuator configured to cause the cam to rotate; a first plane; a second plane; and an interlocking device configured to interlock the first plane and the second plane, and the receiving part may be further configured to securely receive or release the projection part by sliding the first plane in a first direction by a rotation of the cam, and sliding the second plane in a second direction opposite from the first direction by the interlocking device.

The receiving part may be further configured to securely receive or release the projection part by sliding the first plane in the first direction by a force of a first spring, and sliding the second plane in the second direction by a force of a second spring.

The receiving part may include a first plane and a second plane, the first plane may include a first short radius curved part and a first long radius curved part, and the first long radius curved part has a larger radius than the first short radius curved part, the second plane may include a second short radius curved part and a second long radius curved part, and the second long radius curved part has a larger radius than the second short radius curved part, the first short radius curved part overlaps with the second long radius curved part, and the second short radius curved part overlaps with the first long radius curved part, and the receiving part may be further configured to: securely receive or release the projection part by sliding the first short radius curved part in a first direction by an external force to the first long radius curved part, and sliding the second short radius curved part in a second direction opposite from the first direction by an external force to the second long radius curved part.

The receiving part may be further configured to securely receive or release the projection part by sliding the first short radius curved part in the first direction by a force of a first spring, and sliding the second short radius curved part in the second direction by a force of a second spring.

The tool part may include a container, and the arm part is configured to process managing product information for a product housed in the container.

The tool part may further include a memory, and the arm part may be further configured to process the managing product information by processing product information stored in the memory.

The tool part may further include a provision part configured to provide identification information, and the arm part may be further configured to process the managing product information by associating the identification information with the product information and storing the associated identification information and the product information in a memory external to the tool part.

The arm part may be further configured to identify a storage location of the product based on the product information, and to store the product in the storage location.

The product is a food ingredient, and the product information is food ingredient information regarding the food ingredient, and the arm part may be further configure to identify a cooking device based on the food ingredient information, and to transport the food ingredient to the cooking device.

The tool part may include: a container that is microwavable; a plate-shaped member including an electronic shield material; and a memory, and the plate-shaped member is configured to seal a microwave when the container is located within the microwave, and wherein the memory is disposed on a side of the plate-shaped member opposite from an interior of the microwave.

The tool part may include: a container; a fan; and an air bag, and the fan is configured to inflate the air bag, and the air bag is configured to discharge an object housed in the container to an outside of the container when the air bag is inflated.

According to an aspect of the disclosure, a robot system includes: an arm part including a first connection part; a tool part including a second connection part; and at least one processor, wherein the first connection part may include one of a receiving part and a projection part, and the second connection part may include the other one of the receiving part and the projection part, the at least one processor is configured to: control the arm part to connect to the tool part by securely receiving the projection part with the receiving part, and control the arm part to disconnect from the tool part by causing the receiving part to release the projection part.

The projection part may include a front end part, a groove part, and a foundation part, and the receiving part may include a plurality of claws configured to fit between the front end part and the foundation part in the groove part.

The receiving part may further include: a cam; an actuator configured to cause the cam to rotate; and an interlocking device configured to interlock the plurality of claws, and the at least one processor is configured to cause the receiving part to securely receive or release the projection part by sliding a first claw of the plurality of claws in a first direction by a rotation of the cam, and sliding a second claw of the plurality of claws in a second direction different from the first direction by the interlocking device.

The at least one processor may be further configured to cause the receiving part to securely receive or release the projection part by sliding the first claw in the first direction by a force of a first spring, and sliding the second claw in the second direction by a force of a second spring.

The receiving part may include a first plane and a second plane, the first plane may include a first short radius curved part and a first long radius curved part, and the first long radius curved part has a larger radius than the first short radius curved part, the second plane may include a second short radius curved part and a second long radius curved part, and the second long radius curved part has a larger radius than the second short radius curved part, the first short radius curved part overlaps with the second long radius curved part, and the second short radius curved part overlaps with the first long radius curved part, and the at least one processor may be further configured to cause the receiving part to securely receive or release the projection part by sliding the first short radius curved part in a first direction by an external force to the first long radius curved part, and by sliding the second short radius curved part in a second direction opposite from the first direction by an external force to the second long radius curved part.

The tool part may include a container, and the at least one processor may be further configured to process managing product information for a product housed in the container.

The tool part may further include a memory, and the at least one processor may be further configured to process the managing product information by processing product information stored in the memory.

The tool part may further include a provision part configured to provide identification information, and the at least one processor may be further configured to process the managing product information by associating the identification information with the product information and storing the associated identification information and the product information in a memory external to the tool part.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an example of an overall configuration of a food ingredient management system according to one or more embodiments of the disclosure;

FIG. 2 is a perspective view of a tool used in the food ingredient management system according to one or more embodiments of the disclosure;

FIG. 3 is a diagram illustrating a schematic configuration of a lock device according to one or more embodiments of the disclosure;

FIGS. 4A to 4D are diagrams illustrating schematic operations of the lock device according to one or more embodiments of the disclosure;

FIG. 5 is a diagram illustrating a detailed configuration of a first lock device according to one or more embodiments of the disclosure;

FIG. 6 is a diagram illustrating an unlock operation of the first lock device according to one or more embodiments of the disclosure;

FIG. 7 is a diagram illustrating an unlock operation of the first lock device according to one or more embodiments of the disclosure;

FIG. 8 is a diagram illustrating a lock operation of the first lock device according to one or more embodiments of the disclosure;

FIG. 9 is a diagram illustrating a lock operation of the first lock device according to one or more embodiments of the disclosure;

FIG. 10 is a diagram illustrating a detailed configuration of a second lock device according to one or more embodiments of the disclosure;

FIG. 11 is a diagram illustrating a detailed configuration of the second lock device according to one or more embodiments of the disclosure;

FIG. 12 is a diagram illustrating a detailed configuration of the second lock device according to one or more embodiments of the disclosure;

FIG. 13 is a diagram illustrating a detailed configuration of the second lock device according to one or more embodiments of the disclosure;

FIG. 14 is a diagram illustrating an unlock operation of the second lock device according to one or more embodiments of the disclosure;

FIG. 15 is a diagram illustrating an unlock operation of the second lock device according to one or more embodiments of the disclosure;

FIG. 16 is a diagram illustrating an unlock operation of the second lock device according to one or more embodiments of the disclosure;

FIG. 17 is a diagram illustrating a lock operation of the second lock device according to one or more embodiments of the disclosure;

FIG. 18 is a diagram illustrating a lock operation of the second lock device according to one or more embodiments of the disclosure;

FIG. 19 is a diagram illustrating a lock operation of the second lock device according to one or more embodiments of the disclosure;

FIG. 20 is a diagram illustrating a tool integrated with the door of a microwave according to one or more embodiments of the disclosure;

FIGS. 21A to 21C are diagrams illustrating a first introduction method of a food ingredient using a food ingredient carrying and introducing tool according to one or more embodiments of the disclosure;

FIGS. 22A to 22C are diagrams illustrating a second introduction method of a food ingredient using the food ingredient carrying and introducing tool according to one or more embodiments of the disclosure; and

FIGS. 23A and 23B are diagrams illustrating an introduction method of a condiment using a condiment carrying and introducing tool.

### DETAILED DESCRIPTION

Hereinafter, embodiments of the disclosure will be described in detail with reference to the accompanying drawings.

### Food Management System

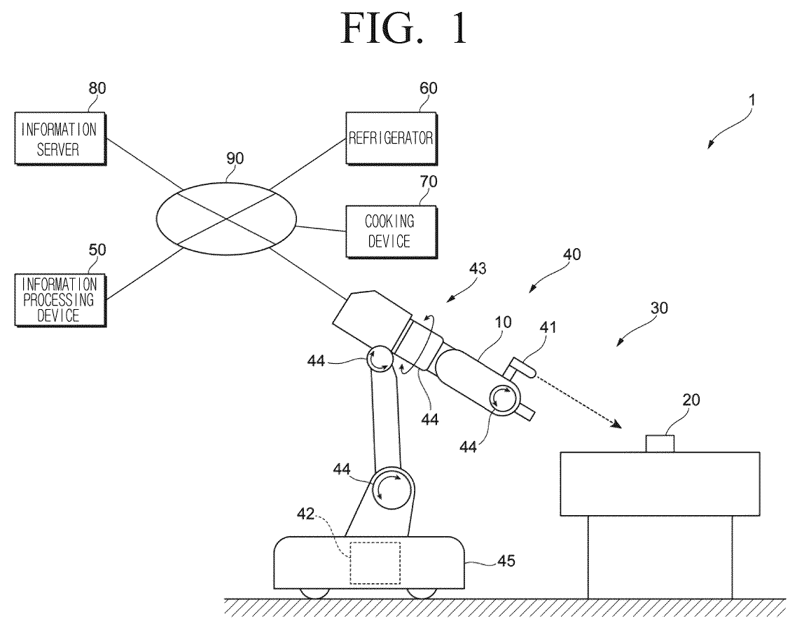

FIG. 1 is a diagram illustrating an example of an overall configuration of a food ingredient management system 1 according to one or more embodiments of the disclosure. The food ingredient management system 1 performs processing such as keeping, transportation, cooking, etc. of various food ingredients by using a robot wherein an end effector of an arm front end is exchangeable, a dedicated tool, etc.

As illustrated in FIG. 1, the food ingredient management system 1 is constructed as a robot 40, an information processing device 50, a refrigerator 60, a cooking device 70, and an information server 80 are connected through a communication circuit 90.

The robot 40 keeps each food ingredient in places that are appropriate for each food ingredient (a refrigerating chamber, a freezing chamber, a storage chamber, etc.), and cooks the food ingredients with appropriate recipes by a user's instructions, etc.

The robot 40 includes a photographing device 41, a control device 42, and a robot main body 43.

The photographing device 41 photographs an image of a tool 20. The photographing device 41 is, for example, a camera. According to one or more embodiments of the disclosure, the photographing device 41 is installed in the front end part of the robot main body 43.

The control device 42 requests a location and a posture of the tool 20 based on a photographed image that was photographed by the photographing device 41. Also, the control device 42 controls the operations of the robot main body 43.

The robot main body 43 grips the tool 20. The tool 20 may have any function, but in the food ingredient management system 1, the tool 20 may have a container housing food ingredients, as an example. The robot main body 43 includes an arm 10 that actually grips the tool 20. The arm 10 includes a plurality of joints. Also, the robot main body 43 includes an actuator 44 that performs a rotating operation by control by the control device 42. In addition, the robot main body 43 according to one or more embodiments of the disclosure is a movable type, and includes a moving part 45 for performing self-propelling.

Also, in the robot 40, input devices such as a touch panel, a microphone, etc., and output devices such as a display, a speaker, etc. may further be provided. In addition, in the robot 40, a device performing communication with the outside may be provided, and the robot 40 may be linked with the information processing device 50, the refrigerator 60, the cooking device 70, etc.

Further, on the arm 10 and the tool 20, a lock device 30 that makes handling of the tool 20 by the arm 10 easy is installed.

The robot 40 is an example of the robot system. The arm 10 is an example of the arm part having a plurality of joints, and the tool 20 is an example of the tool part having any function.

The information processing device 50 may be a computer that a user uses in a home. The information processing device 50 acquires information from the information server 80 through the communication circuit 90. The information processing device 50 may be, for example, a personal computer (PC), a smartphone, etc.

The refrigerator 60 may be a general household refrigerator, but it is assumed to have a wireless communication function. That is, the refrigerator 60 may communicate with the robot 40.

The cooking device 70 may be a general household cooking device such as a microwave, an induction heating (IH) cooking device, an automatic cooking device, etc., but it is assumed to have a wireless communication function. That is, the cooking device 70 may communicate with the robot 40.

The information server 80 may be a server computer that provides information to the robot 40, the information processing device 50, the refrigerator 60, and the cooking device 70. As such information, there is, for example, information wherein food ingredients are matched with appropriate keeping places (i.e., storage locations), appropriate cooking methods, etc.

The communication circuit 90 may be a circuit that is used for the robot 40, the information processing device 50, the refrigerator 60, the cooking device 70, and the information server 80 to transmit and receive information. The communication circuit 90 may be, for example, the Internet.

### Tool

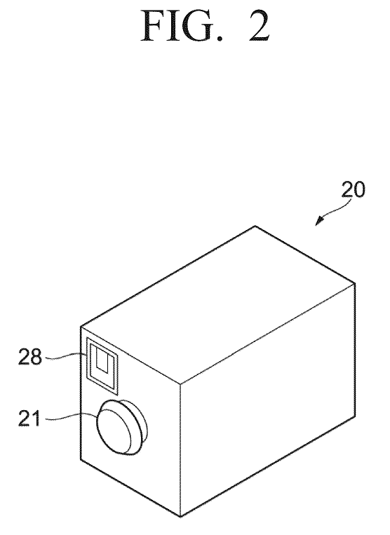

FIG. 2 is a perspective view of the tool 20 used in the food ingredient management system 1.

The tool 20 may, for example, include a container that can store food ingredients, and the container can perform refrigeration, freezing, defrosting, heating, etc. Accordingly, by using this container, it becomes possible to keep food ingredients in a freezer or a refrigerator, and it also becomes possible to heat food ingredients in a microwave or in an IH cooking device.

Also, the tool 20 includes a projection part (a tool side component 21) for making handling by the arm 10 easy. The tool side component 21 will be described later.

In addition, in the tool 20, a marker 28 is provided. The marker 28 includes a tool ID identifying the tool 20, and location and posture information indicating the location and the posture of the tool 20.

### Lock Device

First, an overview of the lock device 30 will be described.

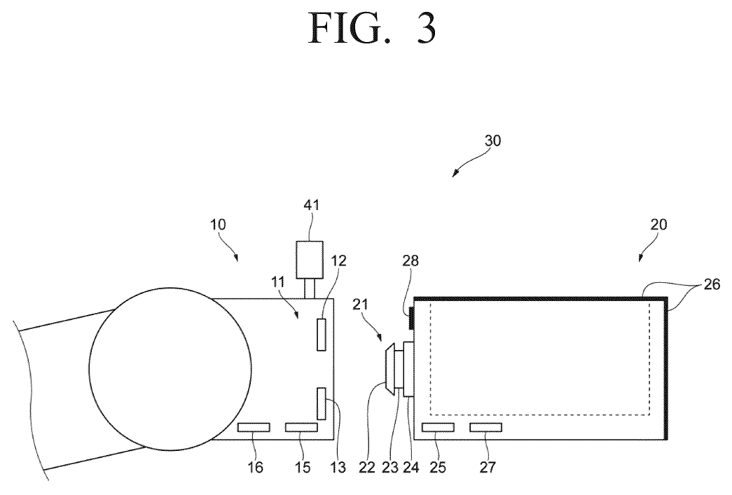

FIG. 3 is a diagram illustrating a schematic configuration of the lock device 30.

As illustrated in the drawing, the arm 10 includes an arm side component 11, and the tool 20 includes a tool side component 21. The arm side component 11 has a female shape, and includes links (or claws) 12, 13. The tool side component 21 has a male shape, and includes a front end part 22, a groove part 23, and a foundation part 24. The arm side component 11 and the tool side component 21 constitute the lock device 30.

Also, the drawing illustrates components other than the lock device 30.

For example, on the tool 20, an electronic tag 25 wherein various kinds of information can be written is installed. In case the tool 20 is used for a microwave, a reading device of the electronic tag 25 is provided in the microwave. Also, in this case, for protecting the electronic tag 25 from microwaves, a surface on the opposite side of the surface facing the arm 10 is covered among the surfaces of the tool 20 in the electronic shield 26. Here, the electronic tag 25 may be a wireless tag such as an RFID tag. The electronic shield 26 may also consist of a steel plate, etc.

Also, in the tool 20, a sensor 27 sensing the temperature, the humidity, the pressure, etc. may be provided.

In addition, the drawing illustrates the marker 28 illustrated in FIG. 2.

Further, in the tool 20, a display that can be read by a user, a solenoid valve for controlling the pressure, etc. may also be provided.

The arm 10 includes an electronic tag reader 15 and a control substrate 16. The control substrate 16 may write various kinds of information on the electronic tag 25, or perform communication with another device via wire or wirelessly.

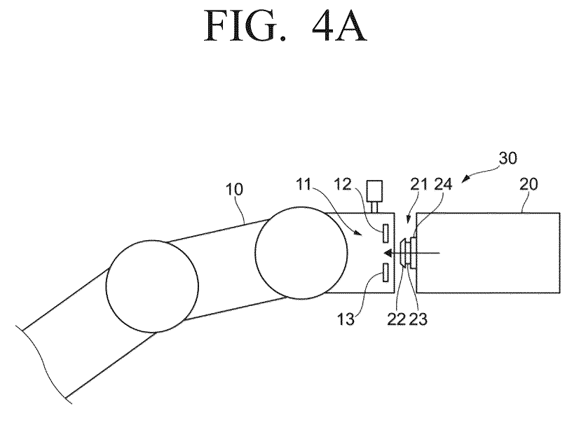

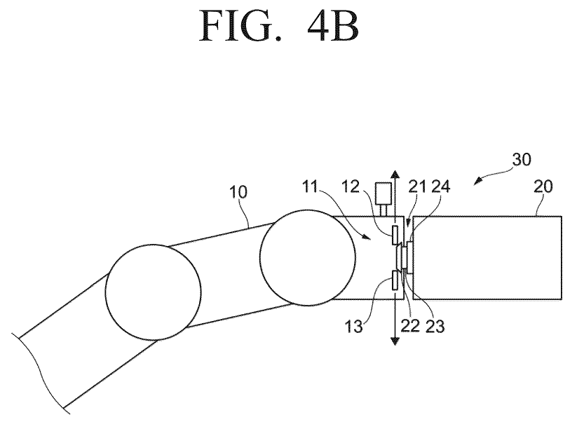

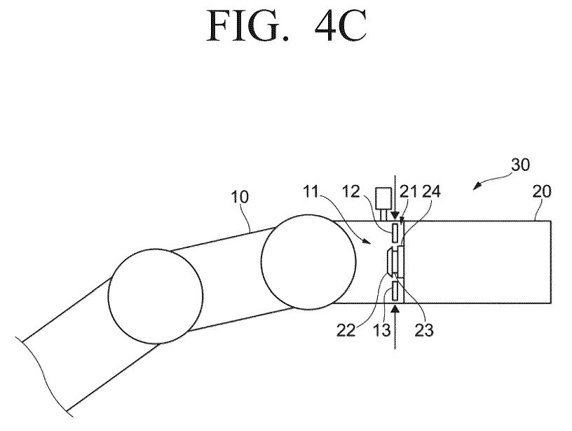

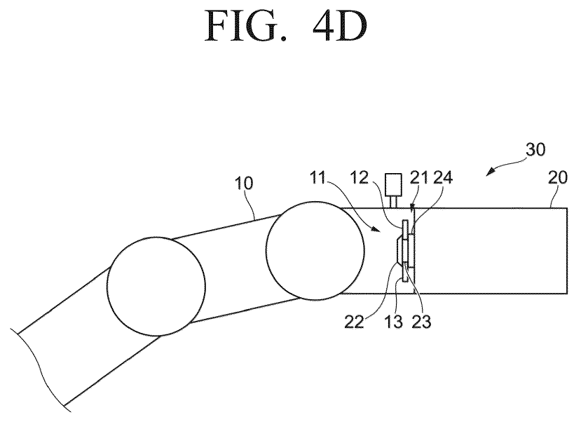

FIGS. 4A, 4B, 4C, 4D are diagrams illustrating schematic operations of the lock device 30.

First, as illustrated in FIG. 4A, the tool side component 21 of the tool 20 gets between the links 12, 13 of the arm side component 11 of the arm 10.

Next, as illustrated in FIG. 4B, the front end part 22 of the tool side component 21 pushes and widens the links 12, 13 of the arm side component 11.

Next, as illustrated in FIG. 4C, the front end part 22 of the tool side component 21 completely enters the inner sides of the links 12, 13 of the arm side component 11.

Afterwards, as illustrated in FIG. 4D, the links 12, 13 of the arm side component 11 are fit together with the groove part 23 of the tool side component 21.

The arm side component 11 is an example of the receiving part, and the tool side component 21 is an example of the projection part. The lock device 30 is an example of the connection part wherein the receiving part makes the arm part and the tool part connected by fitting (i.e., securely receiving) the projection part, and the receiving part makes the connection between the arm part and the tool part release by releasing the hold on the projection part.

Also, in one or more embodiments according to the disclosure, it is described that the arm side component 11 fits the tool side component 21, but the tool side component 21 may fit the arm side component 11. That is, the receiving part may be provided on any one of the arm part and the tool part, and the projection part may be provided on the other one of the arm part and the tool part.

Next, the lock device 30 will be described in detail. Here, two devices will be assumed as the lock device 30, and they will be referred to as a first lock device 31 and a second lock device 32.

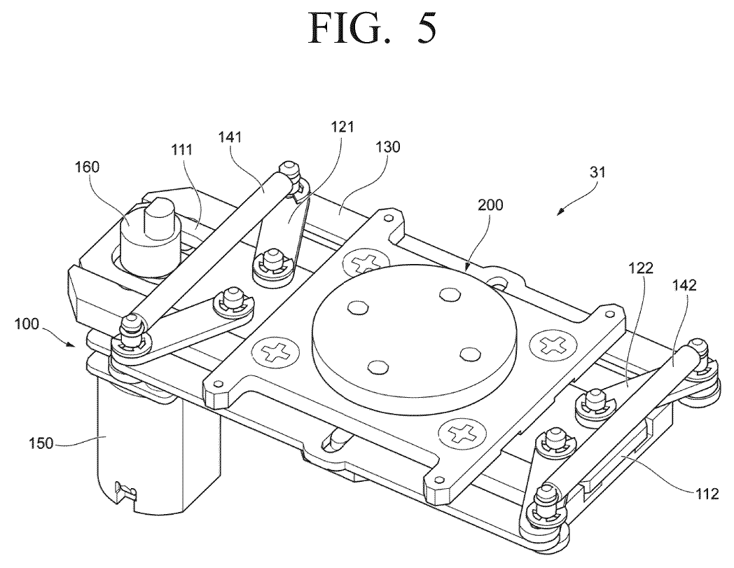

FIG. 5 is a diagram illustrating a detailed configuration of the first lock device 31. The first lock device 31 is an active lock device wherein an actuator is used.

As illustrated in the drawing, the first lock device 31 consists of an arm side component 100 and a tool side component 200. The arm side component 100 includes links 111, 112, 121, 122, 130, springs 141 and 142, an actuator 150, and a cam 160.

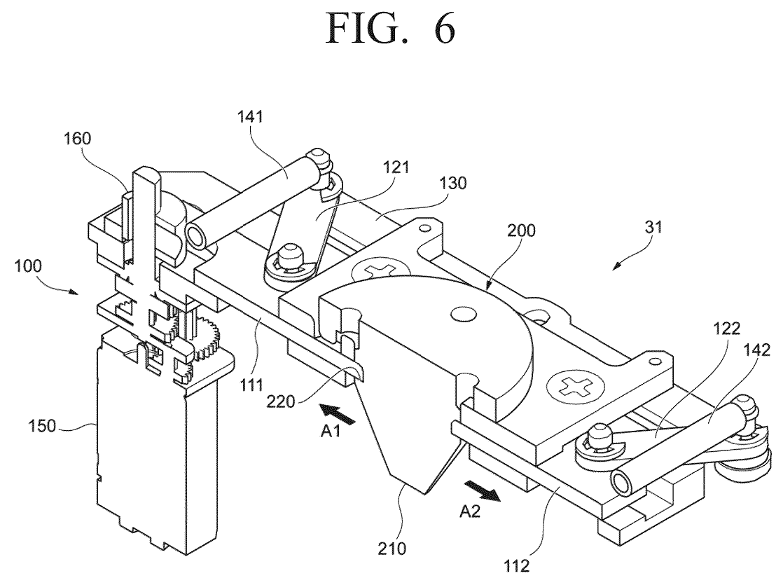

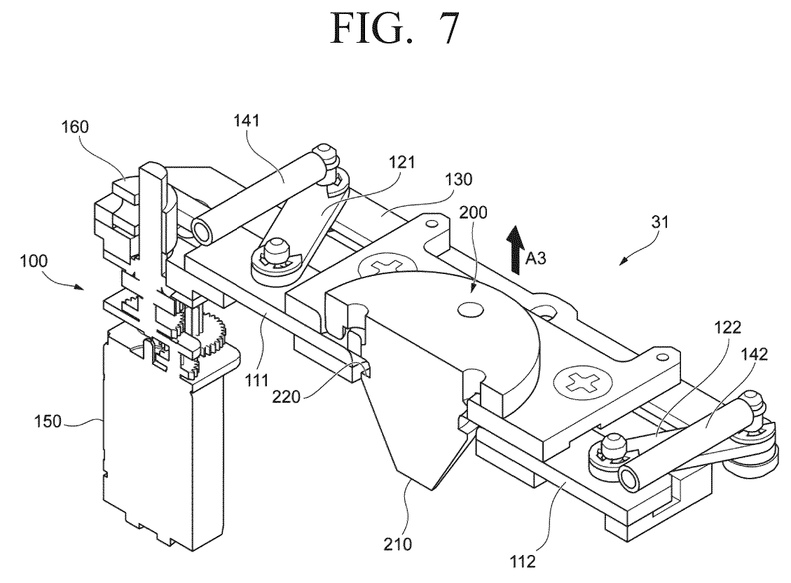

FIG. 6 and FIG. 7 are diagrams illustrating unlock operations of the first lock device 31.

First, as illustrated in FIG. 6, the actuator 150 rotates the cam 160, and the link 111 slides in the direction indicated by the arrow A1. Similarly, the link 112 slides in the direction indicated by the arrow A2 through the links 121, 130, 122. That is, the link 111 and the link 112 move in symmetrical directions with respect to the tool side component 200.

Due to this movement, as illustrated in FIG. 7, the tool side component 200 is unlocked, and becomes movable in the direction indicated by the arrow A3.

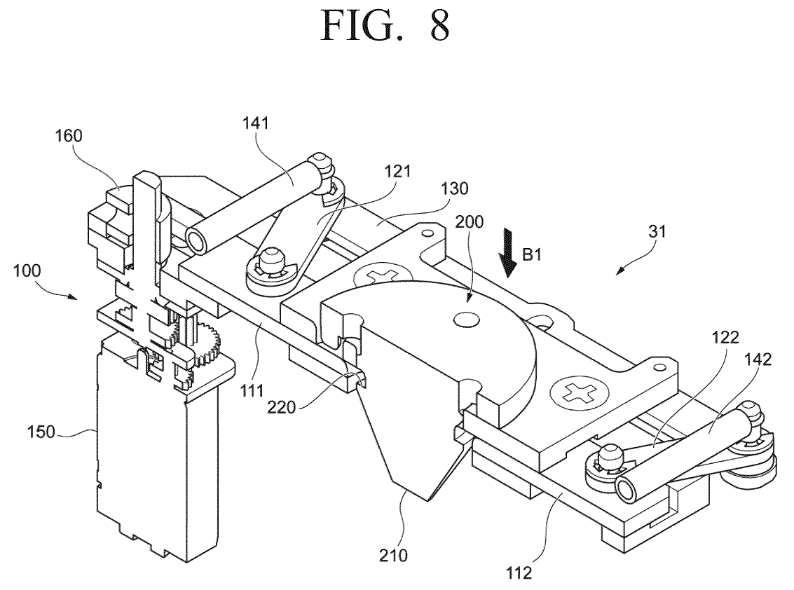

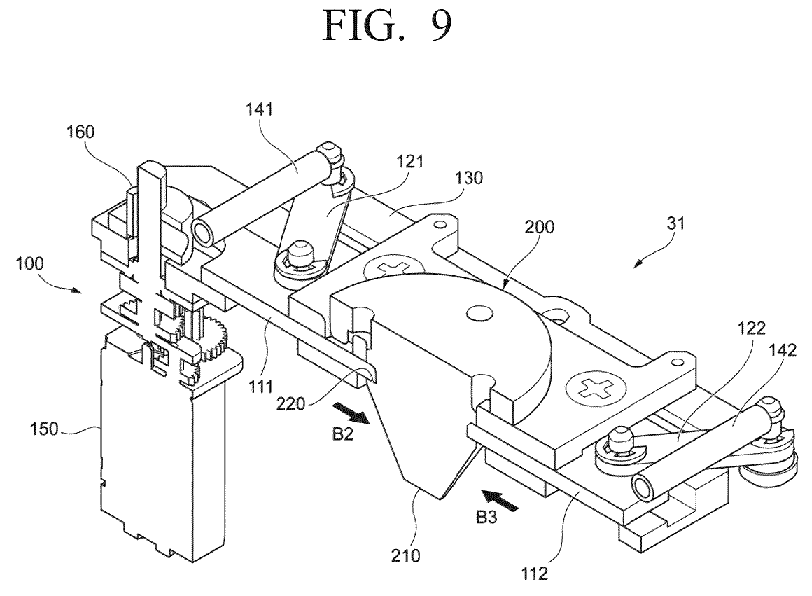

FIG. 8 and FIG. 9 are diagrams illustrating lock operations of the first lock device 31.

First, as illustrated in FIG. 8, if the tool side component 200 is inserted in the direction indicated by the arrow B1, it moves in a direction wherein the links 111, 112 are pushed and opened. Alternatively, the actuator 150 moves in a direction wherein the links 111, 112 are operated and opened, and the tool side component 200 can be inserted in the direction indicated by the arrow B1.

Next, as illustrated in FIG. 9, if the front end part 210 of the tool side component 200 is inserted into the inner sides of the links 111, 112, by the forces of the springs 141, 142, the link 111 is slid in the direction indicated by the arrow B2, and the link 112 is slid in the direction indicated by the arrow B3, respectively. Then, the links 111, 112 are fit together with the groove part 220 of the tool side component 200, and the tool side component 200 is locked.

Also, here, it was assumed that in a lock operation, by the forces of the springs 141, 142, the link 111 is slid in the direction indicated by the arrow B2, and the link 112 is slid in the direction indicated by the arrow B3, respectively, but the disclosure is not limited thereto. The directions of the forces of the springs 141, 142 may be in an opposite direction, and in an unlock operation, by the forces of the springs 141, 142, the link 111 may be slid in the direction indicated by the arrow A1 in FIG. 6, and the link 112 may be slid in the direction indicated by the arrow A2 in FIG. 6, respectively.

The link 111 is an example of the first plane, and the link 112 is an example of the second plane. The links 121, 130, 122 are an example of the interlocking device for interlocking the first plane and the second plane.

The direction indicated by the arrow A1 in FIG. 6 is an example of the first direction when fixing of the projection part is released, and the direction indicated by the arrow A2 in FIG. 6 is an example of the second direction when fixing of the projection part is released. Also, the direction indicated by the arrow B2 in FIG. 9 is an example of the first direction when the projection part is fixed, and the direction indicated by the arrow B3 in FIG. 9 is an example of the second direction when the projection part is fixed.

The arm side component 100 is an example of the receiving part that performs fixing of the projection part or release of the fixing by sliding the first plane in the first direction by the rotation (a circular movement) of the cam, and sliding the second plane in the second direction by the interlocking device. Also, the arm side component 100 is an example of the receiving part that performs fixing of the projection part or release of the fixing by sliding the first plane in the first direction by the force of the spring, and sliding the second plane in the second direction by the force of the spring.

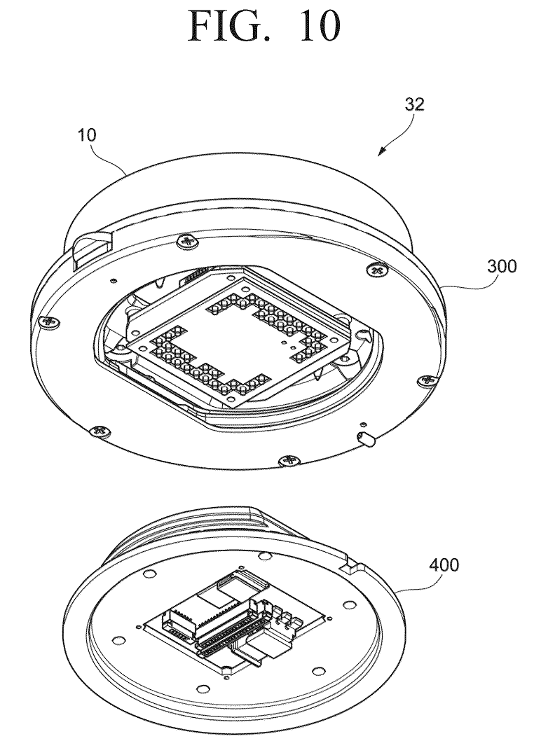

FIGS. 10, 11, 12, and 13 are diagrams illustrating a detailed configuration of the second lock device 32. The second lock device 32 is a passive lock device wherein an actuator is not used.

As illustrated in FIG. 10, the second lock device 32 consists of an arm side component 300 and a tool side component 400.

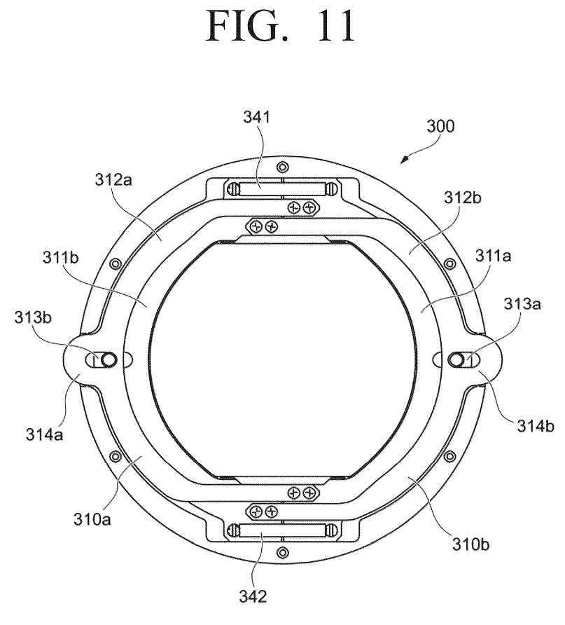

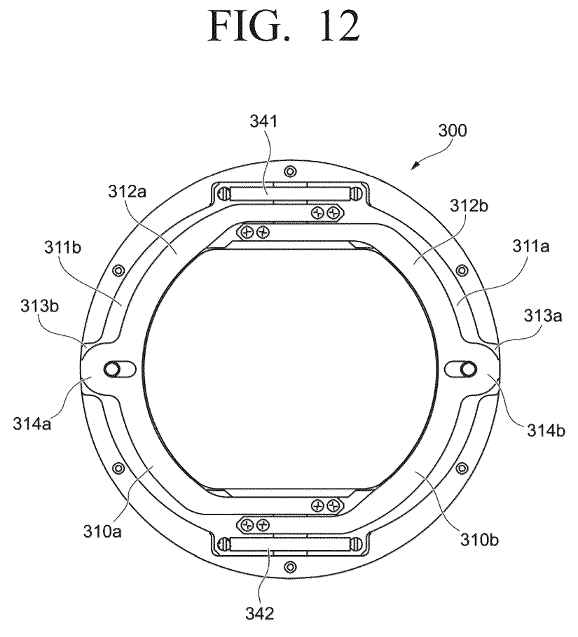

FIG. 11 and FIG. 12 are diagrams illustrating a configuration of the arm side component 300. FIG. 11 illustrates the arm side component 300 in a lock state, and FIG. 12 illustrates the arm side component 300 in an unlock state. As illustrated in the drawings, the arm side component 300 includes links 310a, 310b, and springs 341, 342. The link 310a includes links 311a, 312a, and the link 310b includes links 311b, 312b. Here, as illustrated in FIG. 11, the arm side component 300 locks the tool side component 400 (refer to FIG. 10) by sliding the links 311a, 311b to the inner side, and as illustrated in FIG. 12, the arm side component 300 unlocks the tool side component 400 (refer to FIG. 10) by sliding the links 312a, 312b to the inner side. Accordingly, the radiuses of the links 311a, 311b became smaller than the radiuses of the links 312a, 312b. Also, the links 311a, 311b respectively include projection parts 313a, 313b, and the links 312a, 312b respectively include projection parts 314a, 314b.

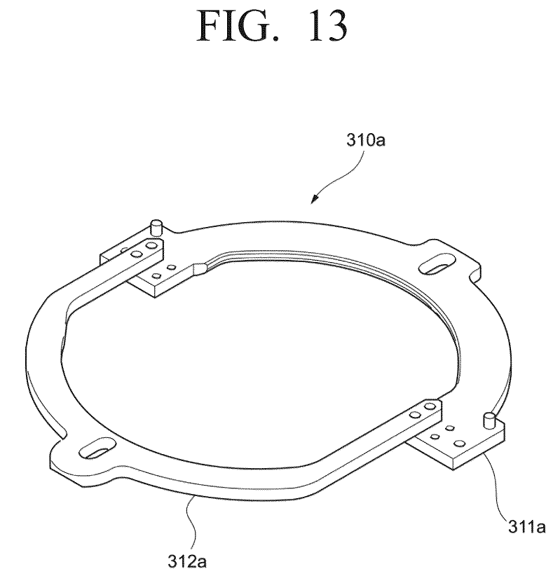

FIG. 13 is a diagram that extracted and illustrated only the link 310a among the above components. As illustrated in the drawing, the plane including the link 311a and the plane including the link 312a are in parallel to each other, but they are dislocated from each other in a vertical direction. Also, the link 311b is also on the plane including the link 311a, and the link 312b is also on the plane including the link 312a. Accordingly, the links 310a, 310b are in a relation of crisscrossing each other stereoscopically while rotated in 180°, such that they may not interfere each other when they slide in left and right sides.

The second lock device 32 performs a lock operation and an unlock operation by using a tool holder.

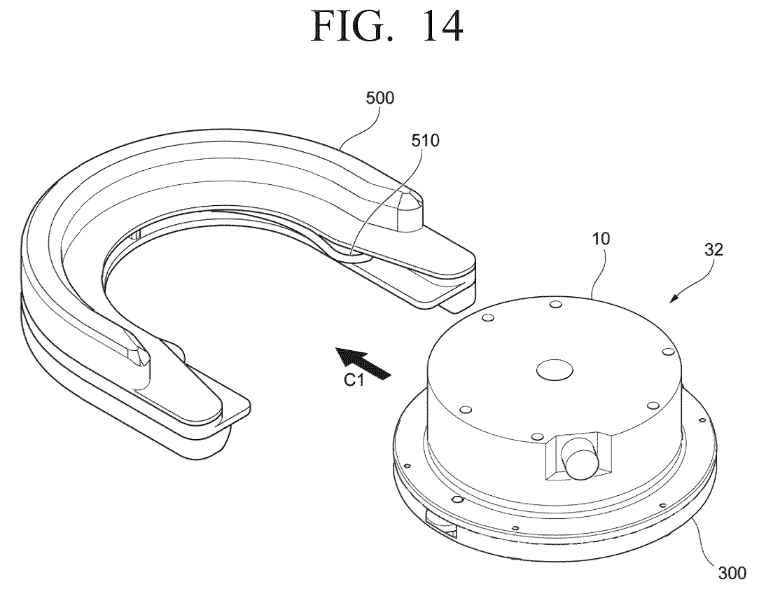

FIGS. 14, 15, and 16 are diagrams illustrating unlock operations of the second lock device 32.

As illustrated in FIG. 14, the arm side component 300 that is docked with the tool side component 400 enters the tool holder 500 from the direction indicated by the arrow C1. Also, here, a state wherein a part of the arm 10 is coupled on the arm side component 300 is illustrated. In addition, the tool side component 400 is unseen as it is hidden under the arm side component 300.

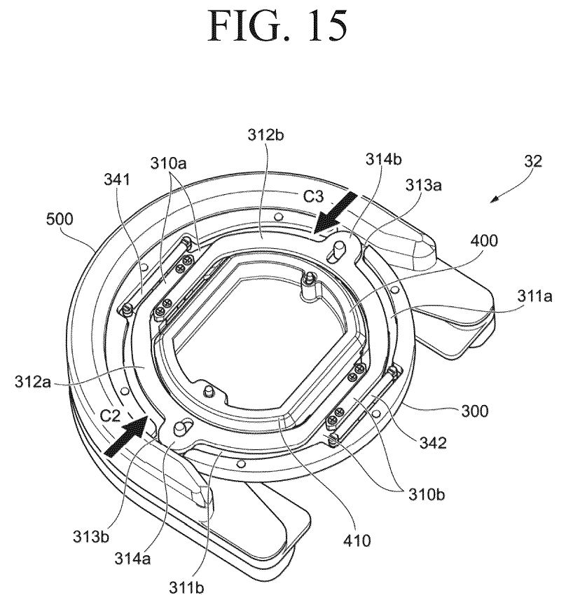

As illustrated in FIG. 15, by the inner wall of the tool holder 500, the projection part 314a of the link 312a is pushed to the direction indicated by the arrow C2, and the projection part 314b of the link 312b is pushed to the direction indicated by the arrow C3, respectively. Due to this, the link 311a is slid in the direction indicated by the arrow C2, and the link 311b is slid in the direction indicated by the arrow C3, respectively, and they get in an unlock state. Also, here, the state of the arm side component 300 is illustrated, and accordingly, a state wherein a part of the arm 10 on the arm side component 300 and the upper surface of the arm side component 300 were removed is illustrated.

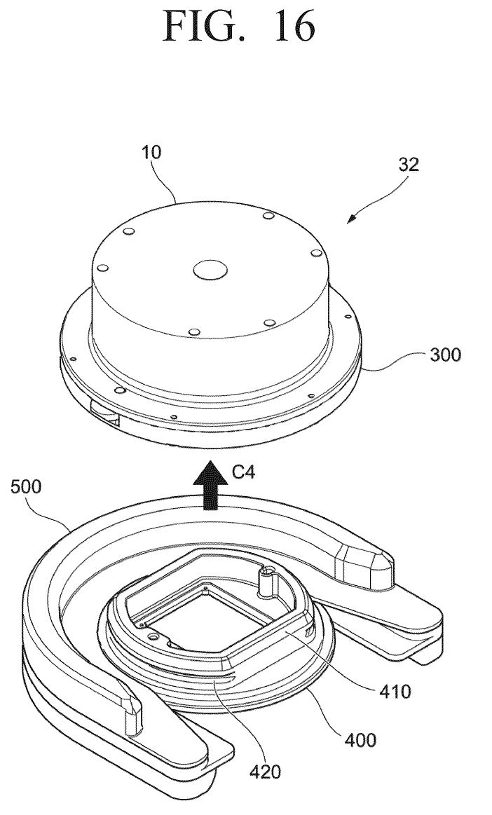

Due to this, as illustrated in FIG. 16, the arm side component 300 becomes movable in the direction indicated by the arrow C4. Also, here, a state wherein a part of the arm 10 is coupled on the arm side component 300 again is illustrated. Here, the spring 510 (refer to FIG. 14) provided on the tool holder 500 calls in the tool side component 400, and accordingly, falling of the tool side component 400 is prevented.

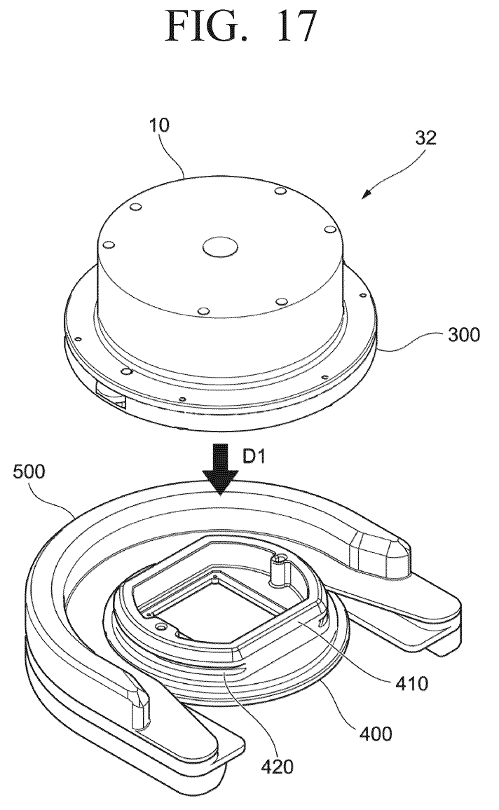

FIGS. 17, 18, and 19 are diagrams illustrating lock operations of the second lock device 32.

First, as illustrated in FIG. 17, the arm side component 300 moves in the direction indicated by the arrow D1 from the upper side of the tool holder 500.

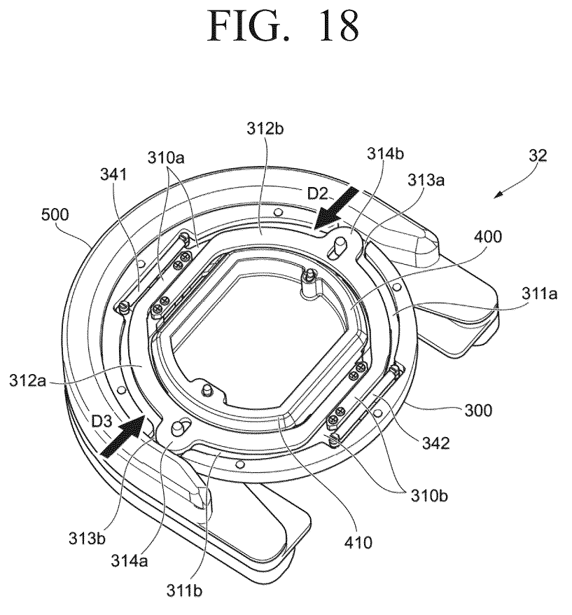

Then, as illustrated in FIG. 18, the links 311a, 311b are pushed and opened by the front end part 410 of the tool side component 400, and are then unlocked. Alternatively, as the projection parts 314a, 314b of the links 312a, 312b are pushed by the inner wall of the tool holder 500, the links 310a, 310b are slid and unlocked. Afterwards, when the tool side component 400 gets between the links 310a, 310b, by the forces of the springs 341, 342, the link 311a is slid in the direction indicated by the arrow D2, and the link 311b is slid in the direction indicated by the arrow D3, respectively. Then, the links 310a, 310b are fit together with the groove part 420 (refer to FIG. 17) of the tool side component 400, and the tool side component 400 is locked.

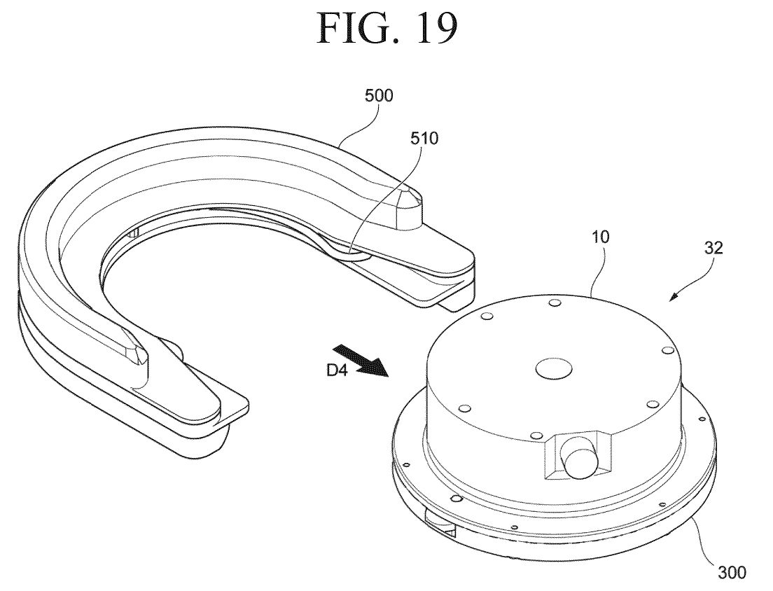

As illustrated in FIG. 19, the arm side component 300 becomes movable in the direction indicated by the arrow D4, in a state of docking the tool side component 400.

Also, here, it was assumed that in a lock operation, by the forces of the springs 341, 342, the link 310a is slid in the direction indicated by the arrow D2, and the link 310b is slid in the direction indicated by the arrow D3, respectively, but the disclosure is not limited thereto. The directions of the forces of the springs 341, 342 may be in an opposite direction, and in an unlock operation, by the forces of the springs 341, 342, the link 310a may be slid in the direction indicated by the arrow C2 in FIG. 15, and the link 310b may be slid in the direction indicated by the arrow C3 in FIG. 15, respectively.

The link 310a is an example of the first plane, the link 311a is an example of the first short radius curved part, and the link 312a is an example of the first long radius curved part. Also, the link 310b is an example of the second plane, the link 311b is an example of the second short radius curved part, and the link 312b is an example of the second long radius curved part.

The direction indicated by the arrow C2 in FIG. 15 is an example of the first direction when fixing of the projection part is released, and the direction indicated by the arrow C3 in FIG. 15 is an example of the second direction when fixing of the projection part is released. Also, the direction indicated by the arrow D2 in FIG. 18 is an example of the first direction when the projection part is fixed, and the direction indicated by the arrow D3 in FIG. 18 is an example of the second direction when the projection part is fixed.

The arm side component 300 is an example of the receiving part that performs fixing of the projection part or release of the fixing by sliding the first short radius curved part in the first direction by an external force to the first long radius curved part, and sliding the second short radius curved part in the second direction by an external force to the second long radius curved part. Also, the arm side component 300 is an example of the receiving part that performs fixing of the projection part or release of the fixing by sliding the first short radius curved part in the first direction by the force of the spring, and sliding the second short radius curved part in the second direction by the force of the spring.

### Operations of the Robot

First, an operation of the robot 40 of keeping a food ingredient will be described.

The robot 40 photographs a food ingredient at the photographing device 41, and the control substrate 16, the information processing device 50, or the information server 80 that received the photographed image recognizes the type of the food ingredient from this image. The type of food is recognized by using the photographing device 41 as above, but in case such recognition is difficult, a user may input the type from the microphone of the robot 40, or the information processing device 50 such as a PC, a smartphone, etc.

The robot 40 puts the food ingredient in the container in the tool 20 by using a robot hand, etc. installed as the tool 20 on the arm 10. Here, in the robot 40, the control substrate 16 recognizes that the food ingredient is stored in the container based on the image photographed at the photographing device 41. Then, the control substrate 16 records that the food ingredient is stored in the container on the electronic tag 25. Alternatively, the control substrate 16 associates that the food ingredient is stored in the container with a tool ID read from the marker 28 photographed by the photographing device 41, and records it on the control substrate 16, the information processing device 50, or the database of the information server 80.

Afterwards, the robot 40 selects an appropriate keeping place of the food ingredient based on the information of the control substrate 16, the information processing device 50, or the information server 80. Then, the robot 40 stores the food ingredient in an appropriate place inside the refrigerator 60 (the refrigerating chamber, the freezing chamber, the special freezing chamber, etc.).

The electronic tag 25 is an example of the memory, and the processing of recording that a food ingredient is stored in the container on the electronic tag 25 is an example of the processing of memorizing product information in the memory.

The marker 28 is an example of the provision part providing identification information of the tool part, and the process of associating that a food ingredient is stored in the container with a tool ID and recording it in the database is an example of the process of associating identification information provided by the provision part and product information, and storing it somewhere other than the tool part.

In this operation of keeping a food ingredient, the arm 10 is an example of the arm part that performs management processing of managing product information on a product housed in the container, and is also an example of the arm part that determines a keeping place of a product based on product information, and keeps the product in the keeping place.

Next, an operation of the robot 40 of transporting a food ingredient will be described.

If a user orders cooking of a food ingredient through a voice, a touch panel manipulation, a manipulation from a mobile phone, etc. with respect to the robot 40, the robot 40 takes out the tool 20 including the container wherein the food ingredient is contained from the refrigerator 60.

Here, the door of the refrigerator 60 is opened automatically or by the arm 10 of the robot 40.

Also, the robot 40 specifies the tool 20 wherein information on the required food ingredient is recorded on the electronic tag 25 based on the information that the electronic tag reader 15 read from the electronic tag 25, and designates the tool 20 as the tool 20 from which the food ingredient should be taken out. Alternatively, the robot 40 acquires a tool ID matched with the type of the required food ingredient from the control substrate 16, the information processing device 50, or the database of the information server 80. Then, the robot 40 specifies the tool 20 wherein the marker 28 includes this tool ID based on the information read by the photographing device 41, and the tool 20 may be designated as the tool 20 from which the food ingredient should be taken out.

Next, the robot 40 identifies the location of the tool 20 based on the image photographed at the photographing device 41, and grips the tool 20 while fitting the lock device 30 of the arm 10 and the tool 20. The lock device 30 is a structure which becomes a male-female pair, as illustrated in FIG. 3 to FIG. 19, and for example, it has a concave part on the side of the arm 10, and has a steel part on the side of the tool 20, and is locked after insertion as a hook device is operated. Afterwards, the robot 40 selects an appropriate cooking device 70 by referring to the information inside the control substrate 16, the information processing device 50, or the information server 80 based on the information on the food ingredient. Then, the robot 40 transports the tool 20 including the container wherein the food ingredient is contained to the cooking device 70.

In this food ingredient transporting operation, the arm 10 is an example of the arm part that determines a cooking device used in cooking of a food ingredient based on information on the food ingredient, and transports the food ingredient to the cooking device.

Next, an operation of the robot 40 of cooking a food ingredient will be described.

The robot 40 arrives at the cooking device 70, and then starts the cooking device 70 by communicating with the cooking device 70. Here, if an automatic start function is attached on the cooking device 70, the robot 40 executes the function, and if an automatic start function is not attached, the robot 40 pushes the switch. Also, for safety, the robot 40 may request permission to the user, and may start the cooking device 70 after permission.

Further, in order that opening or closing of the door of the cooking device 70 is possible by using only the arm 10 even if a robot hand is not attached on the arm 10, a suction pad or a projection in a hook shape may be provided on the arm 10.

An operation of cooking a food ingredient in case the cooking device 70 is a microwave will be described.

The robot 40 places the tool 20 in an appropriate location inside the microwave. A guide device that makes determination of the location of the arm 10 easy may be provided on the microwave and the tool 20, and the robot 40 may make the tool 20 placed in an appropriate location inside the microwave based on this guide device.

The microwave may be designed such that a communication antenna, a connector, etc. are placed in appropriate locations wherein communication with the control substrate 16 or the electronic tag 25 is possible when the tool 20 is placed. The microwave performs communication with the control substrate 16 or reading of the electronic tag 25, and determines the food ingredient inside the container, and cooks the food ingredient with an appropriate recipe according to this determination result.

In the tool 20, the electronic tag 25 is being protected by the electronic shield 26, and thus the function of the tool 20 is not damaged.

A tool 20 integrated with the door of the microwave may also be considered.

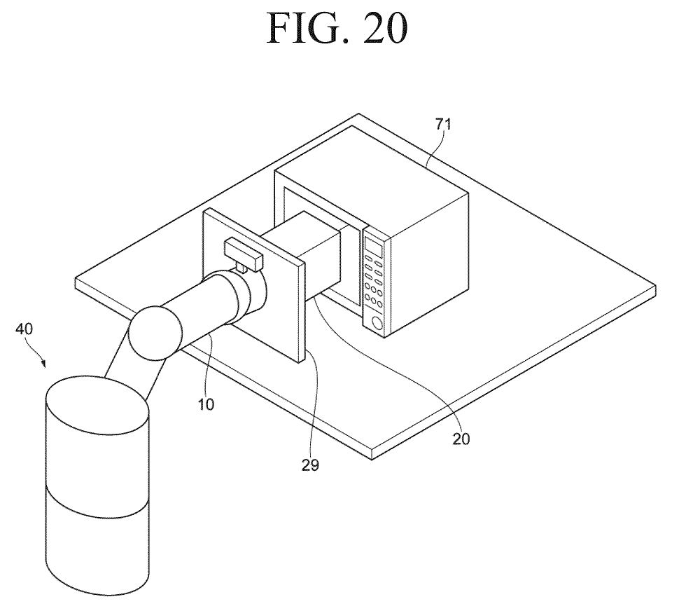

FIG. 20 is a diagram illustrating a tool 20 as above. As illustrated in the drawing, the robot 40 is gripping the tool 20 with the arm 10, and is trying to put the tool 20 inside the microwave 71. Here, the microwave 71 does not have a door. Instead, on the side of the arm 10 of the tool 20, a plate-shaped member 29 consisting of an electronic shield material is provided, and when the tool 20 is housed inside the microwave 71, this plate-shaped member 29 gets to function as the door of the microwave 71. In this case, a configuration wherein the electronic tag 25, the sensor 27, the display, etc. of the tool 20 are arranged in locations on the plate-shaped member 29 which becomes the outer side of the microwave 71, and thus influence of electron beam is not exerted may be adopted. Also, depending on the values of the sensor 27 such as the temperature, the humidity, the pressure, etc., appropriate emission according to overheating due to electron beam and an electronic valve, etc. may be performed on each time.

The plate-shaped member 29 consists of an electronic shield material, and is an example of the plate-shaped member that becomes the door of the microwave when the container is housed in the microwave.

The electronic tag 25 is an example of the memory provided in a location on the plate-shaped member that becomes the outer side of the microwave when it becomes the door of the microwave.

An operation of cooking a food ingredient in case the cooking device 70 is an IH cooking device will be described.

On the bottom of the tool 20 for IH cooking, a metal plate that enables cooking through IH, etc. are provided, and it is possible to perform heating cooking. The robot 40 can perform cooking with a recipe appropriate for a food ingredient, like in a case wherein the cooking device 70 is a microwave.

The sensor 27, the display, etc. are sufficiently distanced from the heating part, and are not made to break down when cooking is performed. Alternatively, a heat insulation material may be installed between the sensor 27, the display, etc. and the heating part.

An operation of cooking a food ingredient in case the cooking device 70 is an automatic device will be described.

In this case, the robot 40 performs cooking according to a recipe, like in a case wherein the cooking device 70 is a microwave.

An operation of cooking a food ingredient in case the cooking device 70 is a food cutter will be described.

The robot 40 introduces a food ingredient into a cutting part of the food cutter. Here, the robot 40 may introduce the food ingredient at once by using a discharge device provided on the container, or introduce the food ingredient by adjusting its amount little by little.

An operation of cooking a food ingredient in case the cooking device 70 is an automatic cooking device having a stirring function will be described.

The robot 40 introduces various food ingredients into an automatic cooking device having a stirring function. These food ingredients include various kinds of condiments. The robot 40 may introduce appropriate condiments or food ingredients on appropriate times.

The robot 40 may perform cooking automatically or semi-automatically by exchanging the tool 20 with a food ingredient carrying and introducing tool or a condiment carrying and introducing tool.

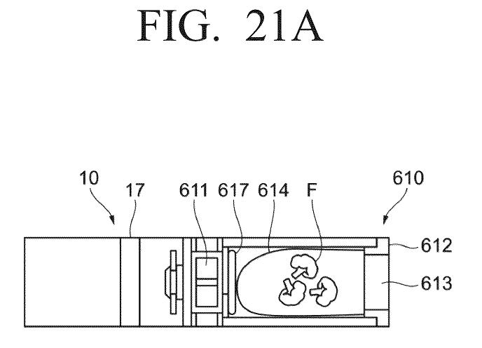

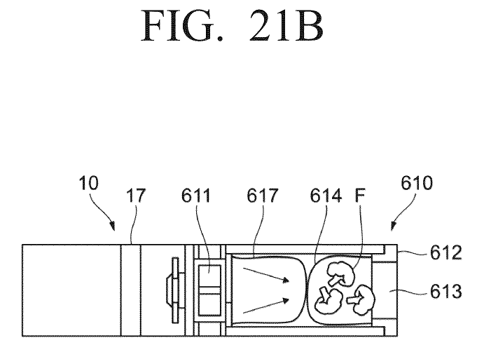

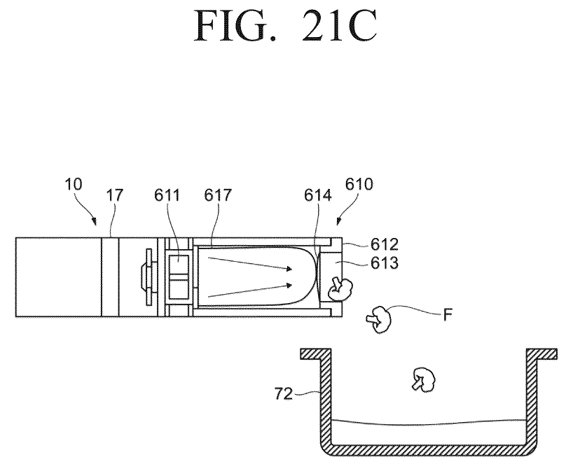

FIGS. 21A, 21B, and 21C are diagrams illustrating a first introduction method of a food ingredient using a food ingredient carrying and introducing tool 610. Also, the tool 610 is illustrated in a state of being gripped by the arm 10.

As illustrated in the drawings, the tool 610 includes an electric fan 611 on the cross-section on the side of the arm 10, and includes a food ingredient lid 612 on the cross-section on the opposite side of the cross-section on the side of the arm 10. The food ingredient lid 612 is provided to enclose the opening part 613. To the food ingredient lid 612, a food ingredient bag 614 is fixed. Inside the food ingredient bag 614, the food ingredient F is housed. When keeping the food ingredient F in the refrigerator 60, etc., the tool 610 may be kept while the food ingredient F is put in the food ingredient bag 614. The food ingredient bag 614 may be a bag dedicated to the tool 610 or a bag for food ingredient sale, and it may be a disposable one, or may be one that is easy to wash. Inside the food ingredient bag 614, an electronic tag may be included. In the tool 610, an air bag 617 is provided in a location that is adjacent to the electric fan 611 and is adjacent to the bottom part of the food ingredient bag 614.

First, as illustrated in FIG. 21A, the bottom part of the food ingredient bag 614 is in a location close to the cross-section on the opposite side of the food ingredient lid 612.

Here, it is assumed that the electric fan 611 initiated air blast to the opposite side of the arm 10. Then, as illustrated in FIG. 21B, the air bag 617 is inflated, and the bottom part of the food ingredient bag 614 moves in the direction of the food ingredient lid 612.

Afterwards, it is assumed that the electric fan 611 initiated air blast to the opposite side of the arm 10. Then, as illustrated in FIG. 21C, the bottom part of the food ingredient bag 614 reaches the location of the food ingredient lid 612, and the food ingredient F pops up from the opening part 613, and is introduced into the pot 72, etc.

On the arm 10, a six axis torque sensor 17 is provided, and the six axis torque sensor 17 senses that the food ingredient F was introduced into the pot 72, etc.

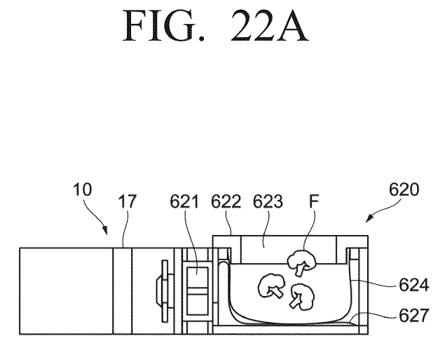

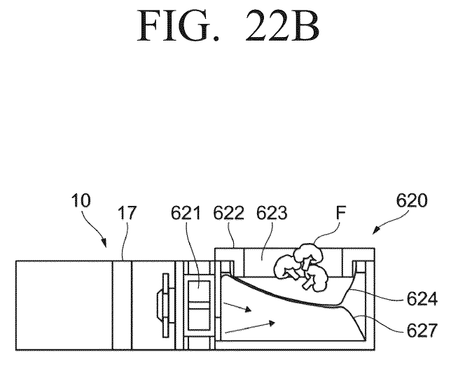

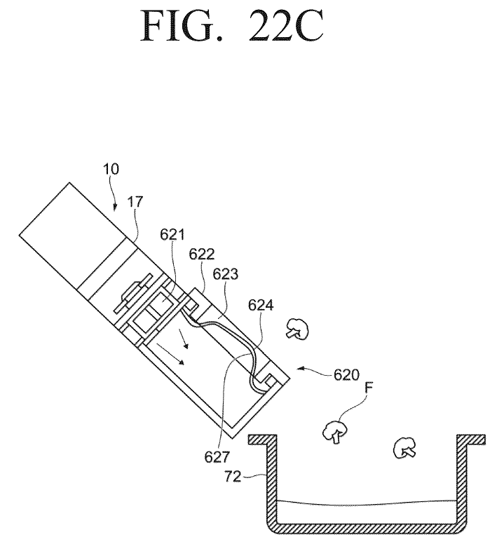

FIGS. 22A, 22B, and 22C are diagrams illustrating a second introduction method of a food ingredient using the food ingredient carrying and introducing tool 620. Also, the tool 620 is illustrated in a state of being gripped by the arm 10.

As illustrated in the drawings, the tool 620 includes an electric fan 621 on the cross-section on the side of the arm 10, and includes a food ingredient lid 622 on the side surface adjacent to the cross-section on the side of the arm 10. The food ingredient lid 622 is provided to enclose the opening part 623. To the food ingredient lid 622, a food ingredient bag 624 is fixed. Inside the food ingredient bag 624, the food ingredient F is housed. When keeping the food ingredient F in the refrigerator 60, etc., the tool 620 may be kept while the food ingredient F is put in the food ingredient bag 624. The food ingredient bag 624 may be a bag dedicated to the tool 620 or a bag for food ingredient sale, and it may be a disposable one, or may be one that is easy to wash. Inside the food ingredient bag 624, an electronic tag may be included. In the tool 620, an air bag 627 is provided across a location adjacent to the electric fan 621 and a location adjacent to the bottom part of the food ingredient bag 624.

First, as illustrated in FIG. 22A, the bottom part of the food ingredient bag 624 is in a location close to the side surface on the opposite side of the food ingredient lid 622.

Here, it is assumed that the electric fan 621 initiated air blast to the opposite side of the arm 10. Then, as illustrated in FIG. 22B, the air bag 627 is inflated, and the bottom part of the food ingredient bag 624 moves in the direction of the food ingredient lid 622.

Afterwards, it is assumed that the electric fan 621 initiated air blast to the opposite side of the arm 10. Then, as illustrated in FIG. 22C, the bottom part of the food ingredient bag 624 reaches the location of the food ingredient lid 622, and when the tool 620 is tilted, the food ingredient F pops up from the opening part 623, and is introduced into the pot 72, etc.

On the arm 10, a six axis torque sensor 17 is provided, and the six axis torque sensor 17 senses that the food ingredient F was introduced into the pot 72, etc.

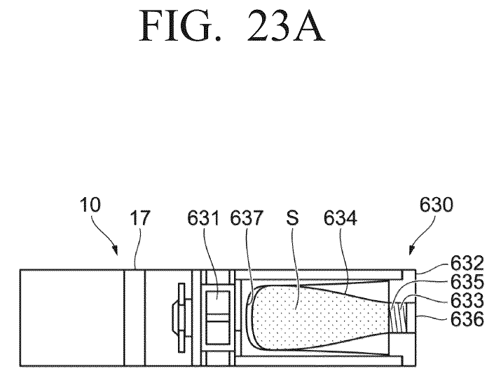

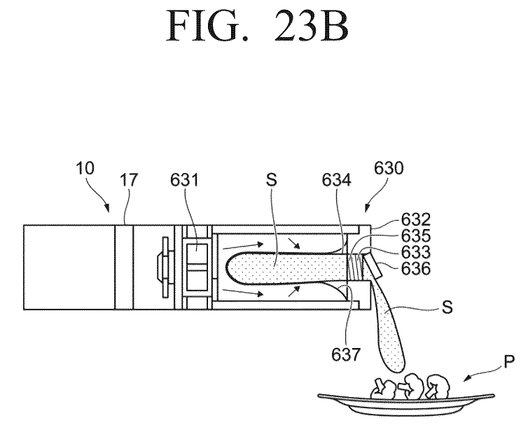

FIGS. 23A and 23B are diagrams illustrating an introduction method of a condiment using the condiment carrying and introducing tool 630. Also, the tool 630 is illustrated in a state of being gripped by the arm 10.

As illustrated in the drawings, the tool 630 includes an electric fan 631 on the cross-section on the side of the arm 10, and includes a condiment lid 632 on the cross-section on the opposite side of the cross-section on the side of the arm 10. On the condiment lid 632, a female thread 633 is provided, and on the outer side of the female thread 633, a check valve 636 is provided. Also, on the condiment lid 632, a condiment bag 634 is fixed as a male thread 635 of the condiment bag 634 is tightened and coupled with the female thread 633 of the condiment lid 632. Inside the condiment bag 634, a condiment S in a liquid or gel shape is housed. The condiment bag 634 may be a bag of a condiment product.

The tool 630 includes an air bag 637 in a location that is adjacent to the electric fan 631 and is adjacent to the bottom part of the condiment bag 634.

First, as illustrated in FIG. 23A, the side surface of the condiment bag 634 is in a location close to the side surface of the condiment carrying and introducing tool 630.

Here, it is assumed that the electric fan 631 initiated air blast to the opposite side of the arm 10. Then, as illustrated in FIG. 23B, the air bag 637 is inflated, and the condiment S pushes out the check valve 636 and pops up to the outer side of the condiment lid 632, and is introduced into the cooking product P.

On the arm 10, a six axis torque sensor 17 is provided, and the six axis torque sensor 17 senses that the condiment S was introduced into the cooking product P.

Also, for introducing a condiment in a powder shape into the cooking device, a tool on which a dedicated milling function is mounted may be used instead of the condiment carrying and introducing tool 630.

The air bags 617, 627, 637 are an example of the air bag that discharges an object housed in the container outside the container as it is inflated by wind from the fan.

Lastly, the safety device will be described.

The robot 40 may determine safety by using image processing or a metal detection sensor, etc. before putting a food ingredient inside the cooking device 70. Then, in the case of determining that there is danger, the robot 40 may warn the user, and make the cooking stopped.

### Modified Embodiment

It was described that embodiments according to the disclosure are applied to the food ingredient management system 1 that manages food ingredients, but the disclosure is not limited thereto. The embodiments according to the disclosure may be further generalized, and applied to a product management system performing management of products. For example, as products, an insecticide, an air freshener, etc. may be considered. In this case, in the same manner as the case of a food ingredient, an electronic tag may be provided on the tool 20. Also, on the tool 20, a temperature and humidity sensor, a fan, a heater, an insecticide, or a holder of an air freshener, etc. are installed. Alternatively, these may be installed on a shelf wherein the tool 20 is housed. On the shelf, a communicator and an operation device may be installed, and the tool 20 may be connected with effectors such as various kinds of sensors, a fan, or a heater, etc.

### Effect

In the embodiments according to the disclosure, the arm 10 and the tool 20 are made to be connected as the arm side component 11 fits the tool side component 21, and the connection between the arm 10 and the tool 20 are made to be released as the arm side component 11 releases the fitting with the tool side component 21. By virtue of this, in the embodiments according to the disclosure, the arm 10 can securely grip the tool 20.

What is claimed is:

1. A robot system comprising:
an arm part;
a tool part; and
a connection part comprising a receiving part and a projection part,
wherein the receiving part is provided on one of the arm part and the tool part, and the projection part is provided on the other one of the arm part and the tool part, and
wherein the receiving part is configured to connect the arm part and the tool part by securely receiving the projection part, and to disconnect the arm part from the tool part by releasing the projection part.

2. The robot system of claim 1, wherein the receiving part comprises:
a cam;
an actuator configured to cause the cam to rotate;
a first plane;
a second plane; and
an interlocking device configured to interlock the first plane and the second plane, and
wherein the receiving part is further configured to securely receive or release the projection part by sliding the first plane in a first direction by a rotation of the cam, and sliding the second plane in a second direction opposite from the first direction by the interlocking device.

3. The robot system of claim 2, wherein the receiving part is further configured to securely receive or release the projection part by sliding the first plane in the first direction by a force of a first spring, and sliding the second plane in the second direction by a force of a second spring.

4. The robot system of claim 1, wherein the receiving part comprises a first plane and a second plane,
wherein the first plane comprises a first short radius curved part and a first long radius curved part, and the first long radius curved part has a larger radius than the first short radius curved part,
wherein the second plane comprises a second short radius curved part and a second long radius curved part, and the second long radius curved part has a larger radius than the second short radius curved part,
wherein the first short radius curved part overlaps with the second long radius curved part, and the second short radius curved part overlaps with the first long radius curved part, and
wherein the receiving part is further configured to:
securely receive or release the projection part by sliding the first short radius curved part in a first direction by an external force to the first long radius curved part, and sliding the second short radius curved part in a second direction opposite from the first direction by an external force to the second long radius curved part.

5. The robot system of claim 4, wherein the receiving part is further configured to:
securely receive or release the projection part by sliding the first short radius curved part in the first direction by a force of a first spring, and sliding the second short radius curved part in the second direction by a force of a second spring.

6. The robot system of claim 1, wherein the tool part comprises a container, and
wherein the arm part is configured to process managing product information for a product housed in the container.

7. The robot system of claim 6, wherein the tool part further comprises a memory, and
wherein the arm part is further configured to process the managing product information by processing product information stored in the memory.

8. The robot system of claim 6, wherein the tool part further comprises a provision part configured to provide identification information, and
wherein the arm part is further configured to process the managing product information by associating the identification information with the product information and storing the associated identification information and the product information in a memory external to the tool part.

9. The robot system of claim 6, wherein the arm part is further configured to identify a storage location of the product based on the product information, and to store the product in the storage location.

10. The robot system of claim 6, wherein the product is a food ingredient, and the product information is food ingredient information regarding the food ingredient, and
wherein the arm part is further configure to identify a cooking device based on the food ingredient information, and to transport the food ingredient to the cooking device.

11. The robot system of claim 1, wherein the tool part comprises:
a container that is microwavable;
a plate-shaped member comprising an electronic shield material; and
a memory, and
wherein the plate-shaped member is configured to seal a microwave when the container is located within the microwave, and wherein the memory is disposed on a side of the plate-shaped member opposite from an interior of the microwave.

12. The robot system of claim 1, wherein the tool part comprises:
a container;
a fan; and
an air bag, and
wherein the fan is configured to inflate the air bag, and the air bag is configured to discharge an object housed in the container to an outside of the container when the air bag is inflated.

13. A robot system comprising:
an arm part comprising a first connection part;
a tool part comprising a second connection part; and
at least one processor,
wherein the first connection part comprises one of a receiving part and a projection part, and the second connection part comprises the other one of the receiving part and the projection part, and
wherein the at least one processor is configured to:
control the arm part to connect to the tool part by securely receiving the projection part with the receiving part, and
control the arm part to disconnect from the tool part by causing the receiving part to release the projection part.

14. The robot system of claim 13, wherein the projection part comprises a front end part, a groove part, and a foundation part, and
wherein the receiving part comprises a plurality of claws configured to fit between the front end part and the foundation part in the groove part.

15. The robot system of claim 14, wherein the receiving part further comprises:
a cam;
an actuator configured to cause the cam to rotate; and
an interlocking device configured to interlock the plurality of claws, and
wherein the at least one processor is configured to cause the receiving part to securely receive or release the projection part by sliding a first claw of the plurality of claws in a first direction by a rotation of the cam, and sliding a second claw of the plurality of claws in a second direction different from the first direction by the interlocking device.

16. The robot system of claim 15, wherein the at least one processor is further configured to cause the receiving part to securely receive or release the projection part by sliding the first claw in the first direction by a force of a first spring, and sliding the second claw in the second direction by a force of a second spring.

17. The robot system of claim 13, wherein the receiving part comprises a first plane and a second plane,
wherein the first plane comprises a first short radius curved part and a first long radius curved part, and the first long radius curved part has a larger radius than the first short radius curved part,
wherein the second plane comprises a second short radius curved part and a second long radius curved part, and the second long radius curved part has a larger radius than the second short radius curved part,
wherein the first short radius curved part overlaps with the second long radius curved part, and the second short radius curved part overlaps with the first long radius curved part, and
wherein the at least one processor is further configured to:
cause the receiving part to securely receive or release the projection part by sliding the first short radius curved part in a first direction by an external force to the first long radius curved part, and by sliding the second short radius curved part in a second direction opposite from the first direction by an external force to the second long radius curved part.

18. The robot system of claim 13, wherein the tool part comprises a container, and
wherein the at least one processor is further configured to process managing product information for a product housed in the container.

19. The robot system of claim 18, wherein the tool part further comprises a memory, and
wherein the at least one processor is further configured to process the managing product information by processing product information stored in the memory.

20. The robot system of claim 18, wherein the tool part further comprises a provision part configured to provide identification information, and
wherein the at least one processor is further configured to process the managing product information by associating the identification information with the product information and storing the associated identification information and the product information in a memory external to the tool part.
